(19) United States
(12) Patent Application Publication
(10) Pub. No.: US 2009/0091262 A1
(43) Pub. Date: Apr. 9, 2009

(54) Discharge lamp lighting apparatus

(75) Inventors: Shingo Takatsuka, Kitasaku-gun (JP); Mitsuo Matsushima, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-gun (JP)

(21) Appl. No.: 12/230,598

(22) Filed: Sep. 2, 2008

(30) Foreign Application Priority Data
Oct. 4, 2007 (JP) 2007-260870

(51) Int. Cl. H05B 41/00

(52) U.S. Cl. 315/119

(57) ABSTRACT

There is provided a discharge clamp lighting apparatus including: a transformer, a transformer driving circuit, a control circuit, in which a primary side of the transformer is driven by the transformer driving circuit lighting a discharge lamp connected at a secondary side of the transformer, a discharge sensing circuit, a signal detecting circuit detecting a voltage signal induced in the discharge sensing circuit, and a protection means stopping supply of electric power to the secondary side of the transformer according to the voltage signal detected at the signal detecting circuit, wherein the signal detecting circuit includes a signal discriminating circuit attenuating a component of a voltage signal inputted from the discharge sensing circuit, the component having a frequency equal to or lower than a predetermined value, to be equal to or greater than a secondary high-frequency pass filter, passing only a high-frequency signal caused by an abnormal discharge.

### BACKGROUND OF THE INVENTION

1. Field of the Invention

The present invention relates to a discharge lamp lighting apparatus suitable for lighting a discharge lamp for illuminating a liquid crystal display device, and particularly to a discharge lamp lighting apparatus provided with a function to detect an abnormal discharge such as a corona discharge or an arc discharge occurring in a high-voltage circuit wiring of the discharge lamp lighting apparatus.

2. Description of the Related Art

In a conventional backlight device used as an illumination device for a liquid crystal display (LCD) device, a discharge lamp such as a cold cathode lamp, metal halide lamp, or the like has been often used, and a discharge lamp lighting apparatus having an inverter circuit and the like is used in order to light the discharge lamp. Normally, the discharge lamp must be lit by a high voltage, and therefore the discharge lamp lighting apparatus is typically provided with a high-voltage transformer to step-up into a high voltage an AC voltage oscillated by a switching operation of a switching element to make up the inverter circuit, and the discharge lamp is connected to the secondary side of the high-voltage transformer.

In the above-described discharge lamp lighting apparatus provided with a high-voltage transformer, when there occurs, for example, a poor connection between terminals of the secondary side of the high-voltage transformer and wires, a broken wire at the secondary side of the high-voltage transformer, a poor connection between high-voltage connector terminals to connect the discharge lamp, or withstand voltage deterioration due to a defective insulation of a coil of the high-voltage transformer, and if the gap (distance) of the disconnected or broken area in the high-voltage circuit wiring is small, then an abnormal discharge such as a corona discharge or an arc discharge may possibly be caused at the disconnected or broken area. When the aforementioned abnormal discharge, for example an arc discharge, occurs, sparks are generated damaging terminals and components, and in some case even smoking and firing may be caused resulting in damaging the discharge lamp lighting apparatus and the LCD device. Accordingly, in the case of a discharge lamp lighting apparatus provided with a high-voltage transformer, it is necessary to detect the occurrence of a corona discharge or an arc discharge to thereby stop supply of electric power to the discharge lamp for the purpose of preventing damages to the discharge lamp lighting apparatus and the LCD device.

Under the circumstance described above, a discharge lamp lighting apparatus is disclosed in which when an abnormal discharge such as a corona discharge or an arc discharge occurs at the secondary side circuit wiring of a transformer, the initial state of the abnormal discharge is detected to thereby protect a circuit (refer to, for example, International Publication Pamphlet No. 2007/069394 hereinafter cited as Patent document 1).

FIG. 10 shows a circuitry of a discharge lamp lighting apparatus 61 described in Patent document 1. The discharge lamp lighting apparatus 61 includes a discharge detecting pattern 68 which has one end connected to ground and has other end connected to a control circuit 63, and which is disposed close to a high-voltage wiring area at the secondary side of a transformer 65 (an area between the secondary side terminal of the transformer 65 and a connector 67 in the figure) whereby electromagnetic waves caused by an abnormal discharge can be reliably received by the discharge detecting pattern 68 in order to accurately detect the initial state of the abnormal discharge.

There is provided another discharge lamp lighting apparatus in which a tube current of a discharge lamp is detected by a current detecting circuit and which includes a protection circuit by which a nose component associated with an arc discharge is extracted from the tube current and detected (refer to, for example, Japanese Patent Publication No. 2002-151287 hereinafter cited as Patent document 2). A discharge lamp lighting apparatus described in Patent document 2 includes a protection circuit 70 which, as shown in FIG. 11, includes a bypass filter 72 disposed at the post-stage of a current detecting circuit 71, and the bypass filter 72 is adapted to pass only a discharge noise frequency component having a frequency substantially higher than an oscillation frequency of an inverter circuit while blocking the oscillation frequency of the inverter circuit.

The discharge lamp lighting apparatuses disclosed in Patent documents 1 and 2, however, have the following problems.

Recently, while demands for reduced power consumption and reduced cost have been increased, it is strongly desired to reduce switching loss of a switching element (for example, a power MOSFET) to constitute an inverter circuit, and therefore turn-on time and turn-off time in the switching operation of the switching element need to be reduced as one means for meeting the desire. This results in that a change in voltage (for example, voltage across drain and source) at the time of turning on and/or turning off the switching element becomes steep thus causing a large overshoot (and/or undershoot) and ringing in the voltage and also making it more likely to happen that a high frequency noise associated mainly therewith (hereinafter referred also to switching noise as appropriate) is caused. Consequently, the circuit element (for example, the discharge detecting pattern 68 in FIG. 10, or the current detecting circuit 71 in FIG. 11) for detecting a high frequency noise associated with an abnormal discharge functions to detect not only a high frequency noise associated with an abnormal discharge which is a signal supposed to be detected but also a switching noise superimposed on the high frequency noise, and therefore an output signal from the circuit element has a small SN ratio resulting in that the protection circuit of the discharge lamp lighting apparatus becomes likely to malfunction.

In this connection, the discharge lamp lighting apparatus disclosed in Patent document 2 includes the bypass filter 72 disposed at the post-stage of the current detecting circuit 71, but the bypass filter 72 functions to pass only a frequency component having a frequency substantially higher than the oscillation frequency of the inverter circuit while blocking an oscillation frequency component of the inverter circuit. Accordingly, as to the arrangement of the bypass filter 72 for achieving the aforementioned function, Patent document 1 describes only that when the oscillation frequency of the inverter circuit ranges from 40 kHz to 100 kHz, and the frequency of the high-frequency voltage generated by an arc discharge ranges from several kHz to several hundred MH, the bypass filter 72 is set to have a passband of several MHz or higher. The switching noise described above, however, typically includes a frequency component of several ten MHz which falls within the passband of the bypass filter 72 described in Patent document 2, and therefore the bypass filter 72 proves not to be effective in eliminating the frequency component of a switching noise from the output voltage of the current detecting circuit 71 to thereby improve the SN ratio.

### SUMMARY OF THE INVENTION

The present invention has been made in light of the problem described above and has as its object to provide a discharge lamp lighting apparatus in which when an abnormal discharge, such as a corona discharge or an arc discharge, occurs, a frequency component caused by a factor other than the abnormal discharge is effectively eliminated from a high frequency detected, whereby the initial state of the abnormal discharge can be accurately detected.

The below-mentioned modes of the present invention are examples for illustrating the composition of the present invention, wherein the present invention is explained on an item-by-item basis in order to allow an easy understanding of the diversified composition of the present invention. The examples are not intended to limit the technical scope of the present invention, and variations in which part of constituent members in each example are substituted or eliminated or in which additional constituent members are provided may be included in the technical scope of the present invention.

(1) A discharge lamp lighting apparatus is provided which includes a transformer, a transformer driving circuit and a control circuit to control the transformer driving circuit, wherein a primary side of the transformer is driven by the transformer driving circuit thereby lighting a discharge lamp connected at a secondary side of the transformer, and which is characterized in that the discharge lamp lighting apparatus further includes a discharge sensing circuit, a signal detecting circuit to detect a voltage signal induced in the discharge sensing circuit, and a protection means to stop supply of electric power to the secondary side of the transformer according to the voltage signal detected at the signal detecting circuit, wherein the signal detecting circuit includes a signal discriminating circuit which attenuates a component of a voltage signal inputted from the discharge sensing circuit, the component having a frequency equal to or lower than a predetermined value, in a manner equal to or greater than a secondary high-frequency pass filter, whereby a high-frequency signal caused by an abnormal discharge is allowed to pass while a high-frequency signal caused by a factor other than the abnormal discharge is blocked from passing (claim 1).

The discharge lamp lighting apparatus described in the present item includes a discharge sensing circuit and a signal detecting circuit to detect a voltage signal induced in the discharge sensing circuit. The signal detecting circuit includes a signal discriminating circuit which passes a high-frequency signal caused by an abnormal discharge while blocking a high-frequency signal caused by a factor other than the abnormal discharge, and therefore it becomes possible to effectively extract only a high-frequency signal caused by an abnormal discharge selectively from all the voltage signals induced in the discharge sensing circuit. Since the signal discriminating circuit attenuates a component of the voltage signal inputted from the discharge sensing circuit, the component having a frequency equal to or lower than a predetermined value, in a manner equal to or greater than a secondary high-frequency pass filter, signal discrimination ability is enhanced.

Accordingly, in the discharge lamp lighting apparatus described in the present item, the difference is sufficiently large in output signal detected at the signal detecting circuit between during operation with an abnormal discharge and during normal operation, and therefore the protection means can detect the initial state of the abnormal discharge with a high accuracy according to the voltage signal detected at the signal detecting circuit thereby stopping supply of electric power to the secondary side of the transformer thus reliably making the discharge lamp lighting apparatus free from smoke and fire problems, and also the protection means can be prevented from malfunctioning when the discharge lamp lighting apparatus operates normally.

(2) In the discharge lamp lighting apparatus described in the item (1), the transformer driving circuit includes a switching element, and a high-frequency noise caused when the switching element is turned on and/or turned off is included in the high-frequency caused by the factor other than the abnormal discharge.

According to the discharge lamp lighting apparatus described in the present item, the high-frequency signal caused when the switching element is turned on and/or turned off (referred to also as switching noise) can be effectively removed from the output signal induced at the discharge sensing circuit. As a result, even in the discharge lamp lighting apparatus in which the switching element is operated at a high speed in order to reduce switching loss for lowering electric power consumption and for cost reduction and consequently a switching noise is likely to occur, the protection means, when an abnormal discharge is caused, can accurately detect the initial state of the discharge according to the voltage signal detected at the signal detecting circuit thereby stopping supply of electric power to the secondary side of the transformer thus reliably making the discharge lamp lighting apparatus free from smoke and fire problems, and also the protection means can be prevented from malfunctioning when the discharge lamp lighting apparatus operates normally.

(3) In the discharge lamp lighting apparatus described in the item (2), the predetermined frequency is set to range preferably from several ten MHz to 500 MHz, and more preferably from 100 MHz to 500 MHz.

The discharge lamp lighting apparatus described in the present item is suitable when the high frequency generated by an abnormal discharge ranges from 100 MHz to 500 MHz, especially the main component thereof ranges from 200 MHz to 300 MHz, and the main component of the high frequency generated by a factor other than the abnormal discharge (for example, switching noise) has a frequency of about several ten MHz.

(4) In the discharge lamp lighting apparatus described in any one of the items (1) to (3), the signal discriminating circuit includes a nth (n≧2) differentiating circuit and either a Schottky barrier diode or an ideal diode circuit connected to the nth differentiating circuit (claim 2).

(5) In the discharge lamp lighting apparatus described in the item (4), the nth (n≧2) differentiating circuit is preferably formed such that a plurality (n) of primary RC differentiating circuits are connected to each other in cascade in n stages.

According to the discharge lamp lighting apparatus described in the item (4), a signal discriminating circuit having an excellent high frequency characteristic can be achieved with a relatively simple and inexpensive structure, and the discharge lamp lighting apparatus described in the item (5) is further advantageous in achieving the signal discriminating circuit described above.

(6) In the discharge lamp lighting apparatus described in any one of the items (1) to (5), the signal detecting circuit further includes a peak holding circuit at the output side of the signal discriminating circuit (claim 3).

According to the discharge lamp lighting apparatus described in the present item, thanks to the peak holding circuit, the peak value of the output signal of the signal discriminating circuit, which is a high-frequency pulse signal, can be detected and held, whereby the occurrence of an abnormal discharge can be reliably captured.

(7) In the discharge lamp lighting apparatus described in any one of the items (1) to (6), the discharge sensing circuit includes a discharge detecting pattern which has one end connected to ground and other end connected to the signal discriminating circuit, and at least one portion of which is located close to a high-voltage wiring of a secondary side circuit of the transformer (claim 4).

According to the discharge lamp lighting apparatus described in the present item, the discharge detecting pattern acts as an antenna, whereby electromagnetic waves emitted in association with a corona discharge and/or an arc discharge can be directly received in a reliable manner, and the initial state of the discharge can be accurately detected. The above composition that one end of the discharge detecting pattern is connected to ground is a structure that is advantageous in detecting an abnormal discharge in a simple and inexpensive manner.

(8) In the discharge lamp lighting apparatus described in the item (7), the discharge lamp lighting apparatus includes at least two sets of connection circuits each of which includes one discharge detecting pattern and one signal discriminating circuit (claim 5).

According to the discharge lamp lighting apparatus described in the present item, since there are provided at least two sets of connection circuits each of which includes one discharge detecting pattern and one signal discriminating circuit, the length of the discharge detecting pattern, while its overall length is maintained substantially at a constant dimension, can be shortened to the extent that the attenuation of the voltage signal induced at each discharge detecting pattern does not lead to problems, compared with a single discharge detecting pattern located close to the high-voltage wiring area of the secondary side circuit of the transformer.

Consequently, in the discharge lamp lighting apparatus described in the present item, the detection sensitivity of an abnormal discharge can be maintained good even when the high-voltage wiring area is relatively large in the case of providing a plurality of transformers in a backlight for, for example, a large LCD display, and/or when a plurality of discharge lamps are lit.

Further, when an abnormal discharge, such as a corona discharge or an arc discharge, occurs in the secondary side circuit wiring, a frequency component caused by a factor other than the abnormal discharge is effectively eliminated from a voltage signal detected at a discharge sensing circuit, whereby the initial state of the abnormal discharge can be accurately detected and the operation of the discharge lamp lighting apparatus can be stopped.

### BRIEF DESCRIPTION OF THE DRAWINGS

FIG. 1 is a conceptual block diagram of a discharge lamp lighting apparatus according to a first embodiment of the present invention;

FIG. 2 is a circuitry of the discharge lamp lighting apparatus according to the first embodiment of the present invention;

FIG. 3 is graph of an attenuation characteristic of a secondary differentiating circuit of the first embodiment of the present invention;

FIG. 4 is a circuit diagram of an example of an ideal diode used as a rectifying element in the present invention;

FIG. 5 is a circuitry of a discharge lamp lighting apparatus according to a second embodiment of the present invention;

FIG. 6 is a diagram of an example of an arrangement of a discharge detecting pattern in the second embodiment of the present invention;

FIG. 7 is a table of SN ratios of abnormal discharge detecting signals of the discharge lamp lighting apparatuses according to the first and the second embodiments and also comparative examples;

FIG. 8 is a circuitry of a discharge lamp lighting apparatus according to a third embodiment of the present invention;

FIG. 9(a) and 9(b) are charts of peak hold effect of the discharge lamp lighting apparatus according to the third embodiment of the present invention, wherein FIG. 9(a) shows a voltage waveform at an output end of an amplification circuit, and FIG. 9(b) shows a voltage waveform at an output end of a peak holding circuit;

FIG. 10 is a circuitry of a conventional discharge lamp lighting apparatus; and

FIG. 11 is a conceptual block diagram of another conventional discharge lamp lighting apparatus.

### DETAILED DESCRIPTION OF THE PREFERRED EMBODIMENTS

Embodiments of the present invention will hereinafter be described with reference to the accompanying drawings.

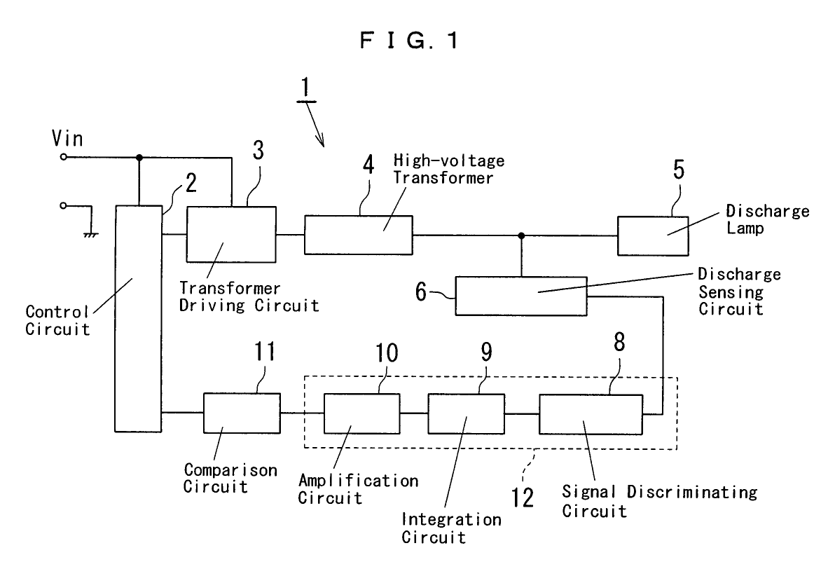

FIG. 1 is a block diagram showing an outline composition of a discharge lamp lighting apparatus 1 according to a first embodiment of the present invention. The discharge lamp lighting apparatus 1 of FIG. 1 includes a high-voltage transformer 4, a transformer driving circuit 3 connected to the input side (primary side) of the high-voltage transformer 4, and a control circuit 2 connected to the transformer driving circuit 3, and a discharge lamp 5, for example a cold cathode lamp, is connected to the output side (secondary side) of the high-voltage transformer 4.

The discharge lamp lighting apparatus 1 further includes a discharge sensing circuit 6 disposed at the secondary side of the high-voltage transformer 4 and adapted to detect an abnormal discharge such as a corona discharge or arc discharge, the output of the discharge sensing circuit 6 is connected to a signal detecting circuit 12, the output of the signal detecting circuit 12 is connected to a comparison circuit 11, and the output of the comparison circuit 11 is connected to a control circuit 2. The signal detecting circuit 12 includes a signal discriminating circuit 8, an integration circuit 9 and an amplification circuit 10 disposed in this order from the discharge sensing circuit 6.

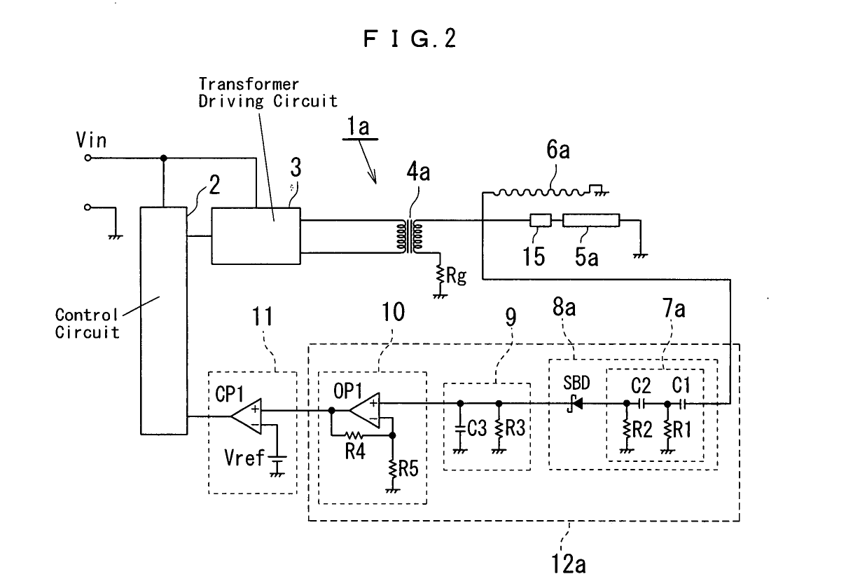

FIG. 2 shows an example circuitry for the discharge lamp lighting apparatus 1 of FIG. 1. In a discharge lamp lighting apparatus la shown in FIG. 2, any component parts corresponding to those of FIG. 1 are noted with the same reference numerals.

The discharge lamp lighting apparatus 1a of FIG. 2 includes a high-voltage transformer 4a, a transformer driving circuit 3 connected to the primary side of the high-voltage transformer 4a, and a control circuit 2 connected to the transformer driving circuit 3, and a discharge lamp 5a, for example a cold cathode lamp, is connected to the secondary side of the high-voltage transformer 4a. In the discharge lamp lighting apparatus 1a, one terminal of the secondary side of the high-voltage transformer 4a is connected via a high-voltage output connector 15 to one terminal of the discharge lamp 5a, and the other terminal of the secondary side of the high-voltage transformer 4a is connected via a resistor Rg to ground. The other terminal of the discharge lamp 5a is connected to ground.

The control circuit 2 includes an oscillation circuit (not shown) to set a driving frequency of the transformer driving circuit 3, and the transformer driving circuit 3 drives the primary side of the high-voltage transformer 4a according to a control signal outputted from the control circuit 2, whereby the discharge lamp lighting apparatus 1a lights the discharge lamp 5a connected to the secondary side of the high-voltage transformer 4a.

The transformer driving circuit 3 is, for example, an H-bridge circuit including four switching elements, and if the switching elements are, for example, power MOSFETs, the output signal from the control circuit 2 is a gate signal to control turning on/off operation of each switching element. The transformer driving circuit 3 converts a DC voltage Vin supplied from an input line into an AC voltage by making the four switching elements perform switching operation at a predetermined timing and drives the primary side of the high-voltage transformer 4a. The high-voltage transformer 4a boosts the AC voltage applied to the primary side and outputs at the secondary aide, and the discharge lamp 5a is lit by the boosted voltage outputted.

The transformer driving circuit 3 in the present embodiment is not limited to an H-bridge circuit but may be an arbitrary appropriate circuit provided with switching elements to drive the secondary side of the high-voltage transformer 4, for example, a half-bridge circuit provided with two switching elements.

The discharge lamp lighting apparatus 1a according to the present embodiment includes a discharge detecting patter 6a as the discharge sensing circuit of the present embodiment, and the discharge detecting pattern 6a has one end connected to ground (GND) and other end connected to a signal discriminating circuit 8a. Further, as schematically shown in FIG. 2, the discharge detecting pattern 6a includes a portion having a waveform (for example, sinusoidal waveform), and the portion is disposed close to a high-voltage wiring area of the secondary side circuit of the high-voltage transformer 4a, more specifically an area between the secondary side terminal of the high-voltage transformer 4a and the high-voltage connector 15.

The waveform of the discharge detecting pattern 6a in the present embodiment may alternatively be a triangular waveform, a rectangular waveform or the like.

The signal discriminating circuit 8a includes a secondary differentiating circuit 7a made up such that a first primary RC differentiating circuit composed of a resistor R1 and a capacitor C1 and a second primary RC differentiating circuit composed of a resistor R2 and a capacitor C2 are connected to each other in cascade in two stages, and a Schottky barrier diode SBD connected to the secondary differentiating circuit 7a. An amplification circuit 10 is a non-inverting amplification circuit including an operation amplifier OP1 and resistors R4 and R5, and the output from the signal discriminating circuit 8a goes via an integration circuit 9 including a resistor R3 and a capacitor C3 and is inputted to a non-inverting input terminal (+) of the operation amplifier OP1. A comparison circuit 11 includes a comparator CP1, and the output from the amplification circuit 10 is inputted to a non-inverting input terminal (+) of the comparator CP1. A reference voltage Vref predetermined is inputted to an inverting input terminal (−) of the comparator CP.

Description will be made now made on a means for detecting a voltage induced by an abnormal discharge at the discharge detecting pattern 6a thereby stopping supply of electric power to the secondary side of the high-voltage transformer 4a, and on the discharge detecting operation in the discharge lamp lighting apparatus 1a described above.

A corona discharge or an arc discharge is generally accompanied by radiation of electromagnetic waves including a high frequency component. When an abnormal discharge such as a corona discharge or an arc discharge occurs at a broken wire of the secondary side circuit of the high-voltage transformer 4a, the discharge detecting pattern 6a functions as an antenna for receiving electromagnetic waves radiated from the discharge, and an induced voltage is generated at the discharge detecting pattern 6a when the discharge detecting pattern 6a receives the electromagnetic waves.

The induced voltage generated at the discharge detecting pattern 6a is inputted as a voltage signal to the signal discriminating circuit 8a. The secondary differentiating circuit 7a included in the signal discriminating circuit 8a functions as a secondary high-frequency pass filter and is adapted to attenuate a frequency component of the voltage signal inputted from the discharge detecting pattern 6a, the frequency component having a frequency equal to or lower than a predetermined frequency, whereby a high-frequency signal generated by the abnormal discharge is allowed to pass while a high-frequency signal (for example, a switching noise to be described later) generated by factors other than the abnormal discharge is blocked from passing, as described later. The high-frequency signal allowed to pass the signal discriminating circuit 8a is rectified by the Schottky barrier diode SBD into a high-frequency pulse signal, and the high-frequency pulse signal goes via the integration circuit 9, is amplified by the amplification circuit 10 up to an appropriate level for comparison and is then inputted to the comparison circuit 11. The voltage signal inputted to the comparison circuit 11 is compared by the comparator CP1 with the predetermined reference voltage Vref, and if the voltage signal inputted exceeds the reference voltage Vref, the output signal of the comparator CP1 is outputted from the comparison circuit 11 as a stop signal for the control circuit 2.

When the stop signal from the comparison circuit 11 is inputted to the control circuit 2, the control circuit 2 stops the operation of the oscillation circuit (not shown) included in the control circuit 2 thereby stopping the operation of the transformer driving circuit 3 thus stopping supply of electric power to the secondary side of the high-voltage transformer 4a. As a result, the corona discharge or the arc discharge caused in the secondary side circuit of the high-voltage transformer 4a is blocked from continuing, whereby the discharge lamp lighting apparatus 1a can be prevented and protected from smoking and firing.

In the present embodiment, the control circuit 2 functions also as a protection means, but the discharge lamp lighting apparatus according to the present invention may incorporate a protection circuit provided separately from the control circuit 2.

The operation of the signal discriminating circuit 8a according to the present embodiment for performing the above-described protective operation for the discharge lamp lighting apparatus 1a will be described in detail.

Various electromagnetic radiation sources are usually present in a discharge lamp lighting apparatus and an object to be illuminated (typically, an LCD device) incorporated in the discharge lamp lighting apparatus. Especially, the switching element included in the transformer driving circuit 3, when turning on and/or off with an increased switching operation speed, acts as a radiation source for a high-frequency noise (switching noise). Under the circumstances, as long as the transformer driving circuit 3 operates, it is highly possible for the discharge detecting pattern 6a to receive the switching noise regardless if the abnormal discharge is occurring or not, and the switching noise constitutes a background noise to a signal to be detected (that is a high-frequency signal caused by the abnormal discharge). Consequently, simply detecting the voltage induced at the discharge detecting pattern 6a results in that the output signal of the signal detecting circuit 12a has a low SN ratio, and therefore it is difficult for the comparison circuit 11 to determine if the abnormal discharge occurs or not, and eventually the protection operation of the discharge lamp lighting apparatus 1a may possibly malfunction.

In the present invention, when addressing the problem describe above, attention is focused on the fact that the frequency of at least the main component of the switching noise normally ranges below the frequency band of at least the main component of the high frequency generated by the abnormal discharge, and a component of the voltage signal inputted from the discharge detecting pattern 6a, which has a frequency equal to or lower than a predetermined frequency, is attenuated, whereby the SN ratio of the detection signal for the abnormal discharge (output signal of the signal detecting circuit 12a) is improved. Further, in the present embodiment, the attenuation is performed at the secondary differentiating circuit 7a, whereby a signal allowed to pass the signal discriminating circuit 8a and a signal to be blocked from passing the signal discriminating circuit 8a are effectively discriminated from each other.

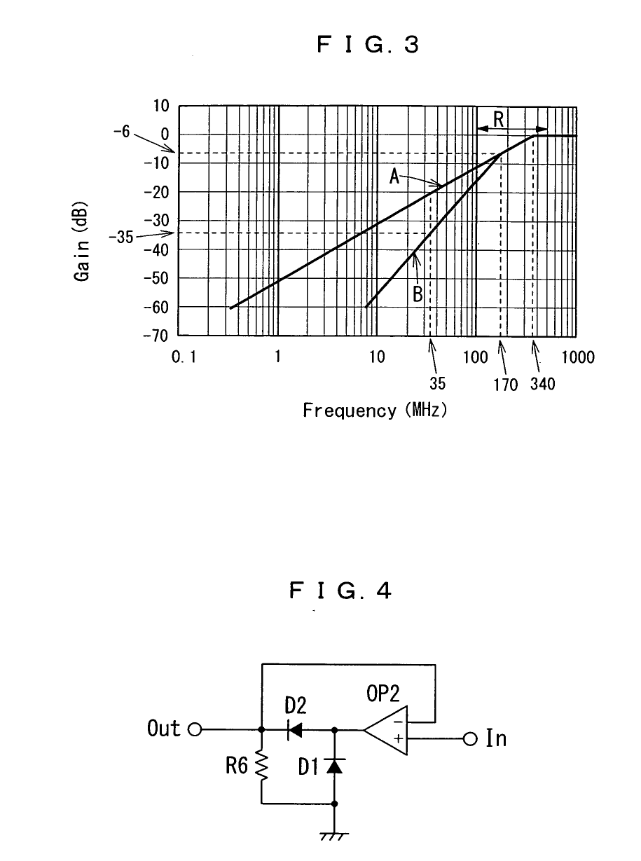

A concrete example of the secondary differentiating circuit 7a will be described with reference to FIG. 3. The example is preferable when the high frequency associated with the abnormal discharge has a frequency band ranging about from 100 MHz to 500 MHz (range indicted by R in FIG. 3), wherein the main component thereof has a frequency band about from 200 MHz to 300 MHz, and also wherein the main component of the switching noise has a frequency of about several ten MHz (for example, 35 MHz).

FIG. 3 shows an attenuation characteristic of the primary and secondary differentiating circuits by a piecewise linear approximation.

Broken line B in FIG. 3 represents a preferred example of attenuation characteristic of the secondary differentiating circuit 7a according to the present embodiment based on a piecewise linear approximation. The attenuation characteristic shown by the broken line B corresponds to the characteristic of a secondary differentiating circuit formed such that a primary differentiating circuit having a cutoff frequency of 340 MHz and a primary differentiating circuit having a cutoff frequency of 170 MHz are connected to each other in cascade, wherein the gain at a frequency of 340 MHz or more is 0 dB, the gain at a frequency of between 170 MHz and 340 MHz has an attenuation slope of 6 dB/OCT, and the gain at a frequency of less than 170 MHz has an attenuation slope of 12 dB/OCT.

Specifically, if the resistors R1 and R2 and the capacitors C1 and C2 of the secondary differentiating circuit 7a shown in FIG. 2 are set to 180 Ω and 91 Ω, and 5 pF and 5 pF, respectively, there can be provided a secondary differentiating circuit which has an attenuation characteristic represented by the broken line B approximately shown in FIG. 3.

Broken line A in FIG. 3 represents, for comparison, an attenuation characteristic of a primary differentiating circuit having a cutoff frequency of 340 MHz based on a piecewise linear approximation, wherein the gain at a frequency of 340 MHz or more is 0 db, and the gain at a frequency of less than 340 MHz has an attenuation slope of 6 dB/OCT.

As shown in FIG. 3, both the primary differentiating circuit shown by the broken line A and the secondary differentiating circuit 7a shown by the broken line B are adapted to attenuate a component of the input signal having a frequency equal to or less than a predetermined frequency of 340 MHz. The attenuation characteristic of the secondary differentiating circuit 7a shown by the broken line B is equivalent to the attenuation characteristic of the primary differentiating circuit shown by the broken line A (substantially proportional to frequency) for a frequency range between 170 MHz and 340 MHz but has a steeper slope (proportional approximately to the square of frequency) than the attenuation characteristic of the primary differentiating circuit a frequency of 170 MHz or less. For example, at a frequency of 170 MHz the gains of both the primary differentiating circuit and the secondary differentiating circuit 7a are −6 dB, but at a frequency of 35 MHz which is a frequency of a main component of the switching noise the gain of the primary differentiating circuit is −20 dB while the gain of the secondary differentiating circuit 7a is −35 dB.

Thus, the secondary differentiating circuit 7a scarcely attenuates a high-frequency component of the voltage signal inputted which is generated by an abnormal discharge and effectively eliminates the switching noise, and consequently the SN ratio of the output signal of the signal detecting circuit 12a can be significantly improved.

Further, since the signal discriminating circuit 8a in the present embodiment includes the Schottky barrier diode SBD, as a rectifying element, which has a forward voltage (about 0.2 V) lower than the forward voltage (about 0.6 V) of a common general-purpose diode, a signal of a lower voltage can be detected, and an abnormal discharge can be detected with a high accuracy.

In the present invention, the rectifying element is not limited to a Schottky barrier diode (SBD), and when the high-frequency signal generated by an abnormal discharge and detected by a discharge detecting pattern has a relatively low voltage, an ideal diode circuit which has a forward voltage of substantially 0 V may be used in place of the Schottky diode. The ideal diode circuit can be made up of, for example, an operation amplifier OP2, diodes D1 and D2, and a resistor R6 as shown in FIG. 4. On the other hand, when the high-frequency signal generated by the abnormal discharge and detected by the discharge detecting pattern has a relatively high voltage, a common general-purpose diode may be used as the rectifying element of the signal discriminating circuit.

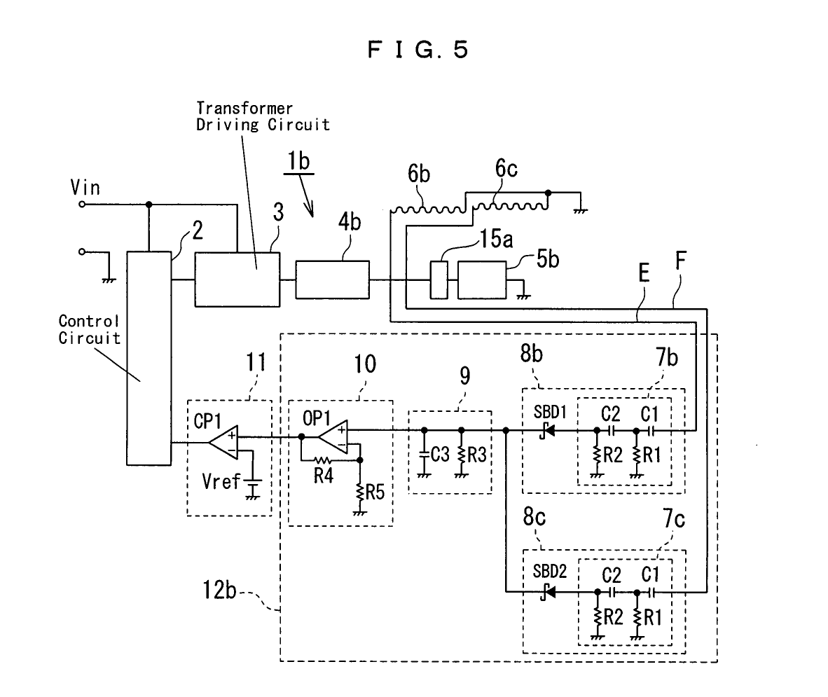

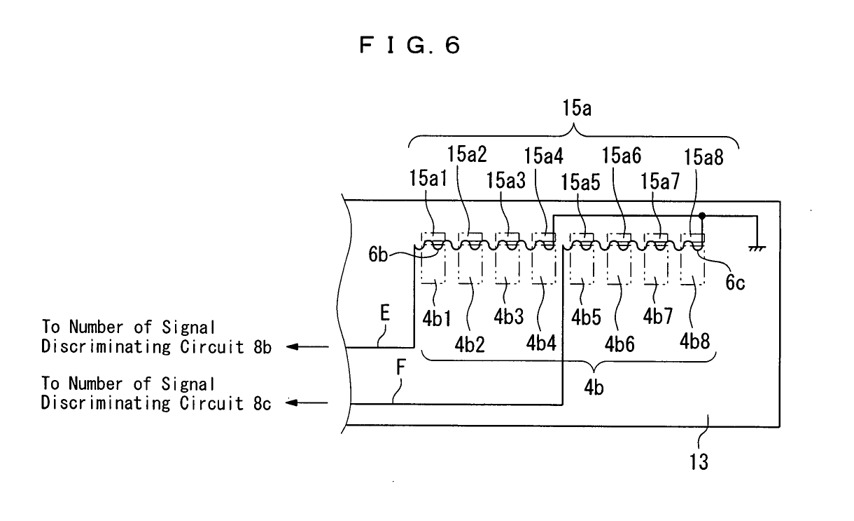

A discharge lamp lighting apparatus according to a second embodiment of the present invention will be described with reference to FIGS. 5 and 6.

FIG. 5 shows a circuitry of a discharge lamp lighting apparatus 1b according to the present embodiment. In FIG. 5, any component parts corresponding to those of the discharge lamp lighting apparatus 1a of FIG. 2 are noted with the same reference numerals, and description will be focused on the difference from the discharge lamp lighting apparatus 1a.

The discharge lamp lighting apparatus 1b includes a transformer group 4 composed of a plurality of high-voltage transformers and lights a discharge lamp group 5b composed of a plurality of discharge lamps, wherein the discharge lamp group 5b is connected to the transformer group 4b via a high-voltage output connector group 15a composed of a plurality of high-voltage output connectors.

In the discharge lamp lighting apparatus 1b according to the present embodiment, a discharge sensing circuit includes two discharge detecting patterns 6b and 6c which have their one terminals connected to ground and their other terminals connected to signal discriminating circuits 8b and 8c, respectively.

In the present embodiment also, the signal discriminating circuit 8b/8c includes a secondary differentiating circuit 7b/7c made up such that a first primary RC differentiating circuit composed of a resistor R1 and a capacitor C1 and a second primary RC differentiating circuit composed of a resistor R2 and a capacitor C2 are connected to each other in cascade in two stages, and a Schottky barrier diode SBD1/SBD2 connected to the secondary differentiating circuit 7b/7c. The output from the signal discriminating circuit 8b/8c passes via an integration circuit 9, is amplified by an amplification circuit 10, and then inputted to a comparison circuit 11 which outputs a stop signal to a control circuit 2 when a voltage signal inputted exceeds a reference voltage Vref.

With the structure described above, the discharge lamp lighting apparatus 1b according to the present embodiment performs the same operation as the discharge lamp lighting apparatus 1b of FIG. 2 according to the first embodiment and also performs the following operation specific to the present embodiment.

In the case of a discharge lamp lighting apparatus like the discharge lamp lighting apparatus 1b including the transformer group 4b and adapted to light the discharge lamp group 5b, the high-voltage wiring area of the secondary side circuit of a transformer, at which a discharge detecting pattern is disposed, is relatively large, and therefore the discharge detecting pattern must have an increased length. When the distance is increased from the high-frequency detecting portion of the discharge detecting pattern to a signal discriminating circuit, an induced voltage signal, before reaching a signal discriminating circuit, is attenuated while passing through the discharge detecting pattern, which may possibly result in decreasing the SN ratio of the output signal from a signal detecting circuit 12b thus deteriorating the detecting sensitivity for an abnormal discharge.

In addressing the problem described above, the discharge lamp lighting apparatus 1b according to the present embodiment includes a discharge detecting pattern composed of the two discharge detecting patterns 6b and 6c which are connected respectively to the signal discriminating circuits 8b and 8c, whereby the length of each of the discharge detecting patters 6b and 6c can be shortened to such an extent as not to develop the voltage signal attenuation problem while the discharge detecting pattern maintains a certain overall length. As a result, even when the high-voltage wiring area of the secondary side circuit of the transformer, at which the discharge detecting pattern is disposed, is relatively large, the SN ratio of the output signal from the signal detecting circuit 12b is prevented from deteriorating and a good detection sensitivity for an abnormal discharge can be maintained.

In the present embodiment, the discharge detecting patterns 6b and 6c include a portion having a waveform (for example, sinusoidal waveform),and the portion is disposed close to a high-voltage wiring area of the secondary side circuit of the high-voltage transformer group 4b, more specifically an area between the secondary side terminal of each of the high-voltage transformers and each of the high-voltage connectors of the high-voltage output connector group 15a, and a suitable example of arrangement of the discharge detecting patterns 6b and 6c will be described with reference to FIG. 6.

FIG. 6 is a plan view of a side face (hereinafter referred to as an “underside face” as appropriate) of a printed board 13 opposite to a side face on which a plurality (eight in the figure) of high-voltage transformers 4b1 to 4b8 to make up the transformer group 4b, and a plurality (eight in the figure) of high-voltage output connectors 15a1 to 15a8 to make up the high-voltage output connector group 15a are mounted. In FIG. 6, a portion corresponding to the area on which each of the high-voltage transformers 4b1 to 4b8 is mounted is indicated by a rectangular region defined by a two-dot chain line with a reference numeral corresponding to the reference numeral of the member mounted, and a portion corresponding to the area on which each of the high-voltage output connectors 15a1 to 15a8 is mounted is indicated by a rectangular region defined by a one-dot chain line with a reference numeral corresponding to the reference numeral of the member mounted. In the printed board 13, the terminals of the secondary side of each of the high-voltage transformers 4b1 to 4b8 are disposed in a location (upper side in FIG. 6) to face each corresponding one of the high-voltage output connectors 15a1 to 15a8.

In the present embodiment, the discharge detecting patterns 6b and 6c are formed at the underside face of the printed board 13 such that the waveform portion of the discharge detecting pattern 6b runs between portions (the rectangular regions with the reference numerals 4b1 to 4b4 in FIG. 6) corresponding to the areas having the high-voltage transformers 4b1 to 4b4 mounted thereon and portions (the rectangular regions with the reference numerals 15a1 to 15a4 in FIG. 6) corresponding to the areas having the high-voltage connectors 15a1 to 15a4 mounted thereon wherein the waveform portion is positioned close to or in overlap with both the portions 4b1 to 4b4 and the portions 15a1 to 15a4, and such that the waveform portion of the discharge detecting pattern 6c runs between portions (the rectangular regions with the reference numerals 4b5 to 4b8 in FIG. 6) corresponding to the areas having the high-voltage transformers 4b5 to 4b8 mounted thereon and portions (the rectangular regions with the reference numerals 15a5 to 15a8 in FIG. 6) corresponding to the areas having the high-voltage output connectors 15a5 to 15a8 mounted thereon wherein the waveform portion is positioned close to or in overlap with both the portions 4b5 to 4b8 and the portions 15a5 to 15a8.

Thus, in the present embodiment, the discharge detecting patterns 6b and 6c are located close both to the secondary side terminals of the high-voltage transformers 4bl to 4b8 and to the high-voltage connectors 15a to 15a8, and consequently the initial state of the discharge can be further accurately detected.

Needless to say, also in the case of a discharge lamp lighting apparatus like the discharge lamp lighting apparatus 1a of FIG. 2 in which the discharge sensing circuit is made up of one discharge detecting pattern 6a, it is possible that the discharge detecting pattern 6a is formed at the underside face of a printed board on which the high-voltage transformer 4a and the high-voltage output connector 15 are mounted, such that the waveform portion of the discharge detecting pattern 6a runs between a portion corresponding to an area of the printed board having the high-voltage transformer 4a mounted thereon and a portion corresponding to an area of the printed board having the high-voltage output connector 15 mounted thereon wherein the waveform portion is positioned close to or in overlap with both of the corresponding portions.

In the discharge lamp lighting apparatus 1b according to the present embodiment, there are provided two sets of series connection circuits each made up of a discharge detecting pattern and a signal discriminating circuit, specifically one is a connection of the discharge detecting pattern 6b and the signal discriminating circuit 8b, and the other is a connection of the discharge detecting pattern 6c and the signal discriminating circuit 8c.

In the discharge lamp lighting apparatus according to the present invention, in order to maintain a good detecting sensitivity of an abnormal discharge with a plurality of sets of series connection circuits while taking advantage of the feature that a discharge sensing circuit includes a discharge detecting pattern which has one end connected to ground whereby an abnormal discharge can be detected with a simple and inexpensive structure, it is preferable that the number of the aforementioned sets of series connection circuits be reduced to the minimum number possible, at least to a number smaller than the number of the plurality of high-voltage transformers and/or the plurality of discharge lamps insofar as the voltage signal induced at the discharge detecting pattern included in each series connection circuit set has such a length as to allow an adequate level to be maintained until it reaches the corresponding signal discriminating circuit.

In this respect, the discharge lamp lighting apparatus 1b according to the present embodiment, which includes two sets of series connection circuits each made up respectively of the discharge detecting pattern 6b/6c and the signal discriminating circuit 8b/8c in the discharge lamp lighting apparatus including eight high-voltage transformers 4b1 to 4b8, is an example composition in which an advantage that an abnormal discharge can be detected with a simple and inexpensive structure is highly balanced with an advantage that an abnormal discharge can be detected with a high sensitivity in a spread illuminating apparatus suitable for use as a backlight, for example, in a large LCD display.

In the present invention, however, the number of the series connection circuit sets is optimally determined in consideration of the overall length of the discharge detecting pattern to be ensured according to the numbers of the high-voltage transformers and the discharge lamps, the allowable attenuation level of the signal in the discharge detecting pattern, the cost associated with an increase in the number of the series connection circuit sets, and the like, and may be more than two where appropriate.

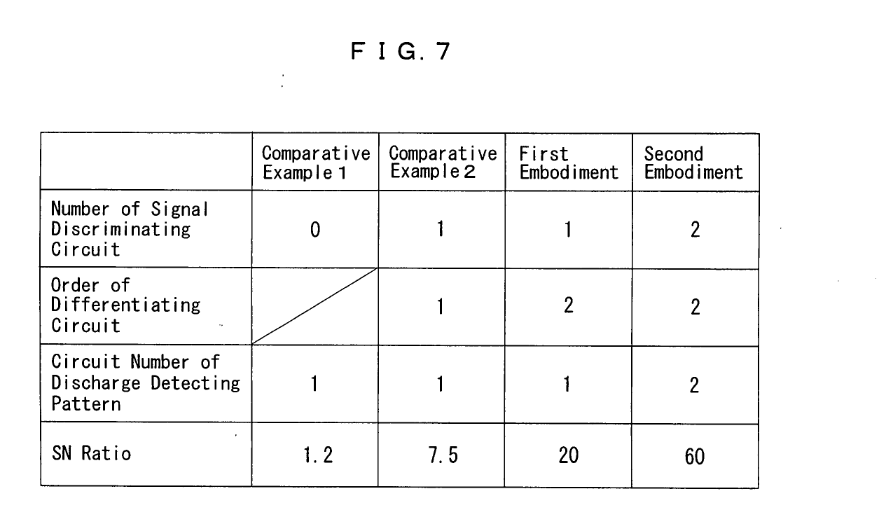

FIG. 7 is a table of measurements of the SN ratios of the signal detecting circuits 12a and 12b of the discharge lamp lighting apparatus 1a and 1b according respectively to the first and second embodiments described above. FIG. 7 further includes measurements of a comparable SN ratio of a discharge lamp lighting apparatus (Comparative example 1) which includes one discharge detecting pattern like in the first embodiment but no signal discriminating circuit and a comparable SN ratio of a discharge lamp lighting apparatus (Comparative example 2) which includes one discharge detecting pattern like in the first embodiment and a signal discriminating circuit including a primary differentiating circuit and connected to the discharge detecting pattern.

The SN ratio shown in FIG. 7 is defined by “Va/Vn”, where Va is an effective value of an output signal of the signal detecting circuit measured when the discharge lamp lighting apparatus is operated with a gap of 0.5 mm provided between a discharge lamp and a high-voltage output connector thereby causing an abnormal discharge, and Vn is an effective value of the signal detecting circuit measured when the discharge lamp lighting apparatus is normally operated.

Referring to FIG. 7, the SN ratios of the comparative examples 1 and 2, and the first and second embodiments are 1.2, 7.5, 20 and 60, respectively. Thus, it turns out that the SN ratios of the discharge lamp lighting apparatuses 1a and 1b of the first and second embodiments are significantly improved compared with the SN ratios of the discharge lamp lighting apparatuses of the comparative examples 1 and 2, and especially the discharge lamp lighting apparatus 1b of the second embodiment shows a striking improvement.

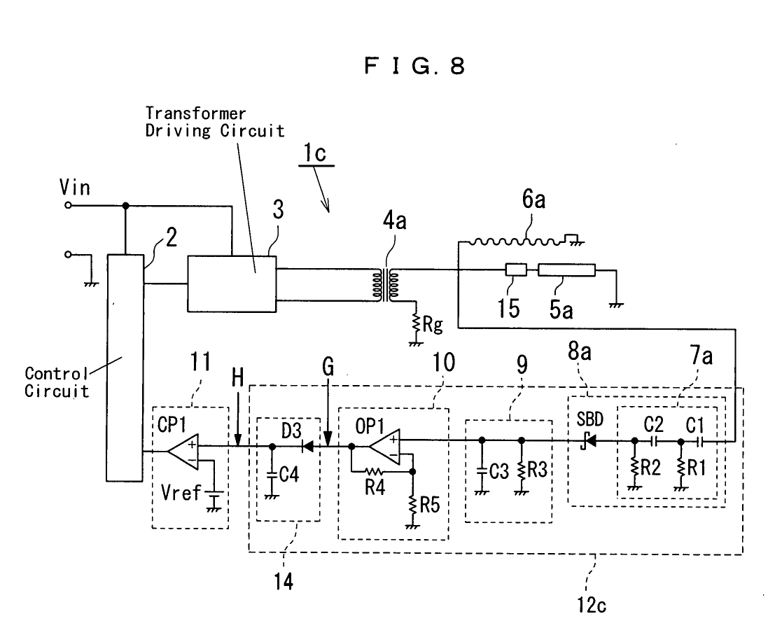

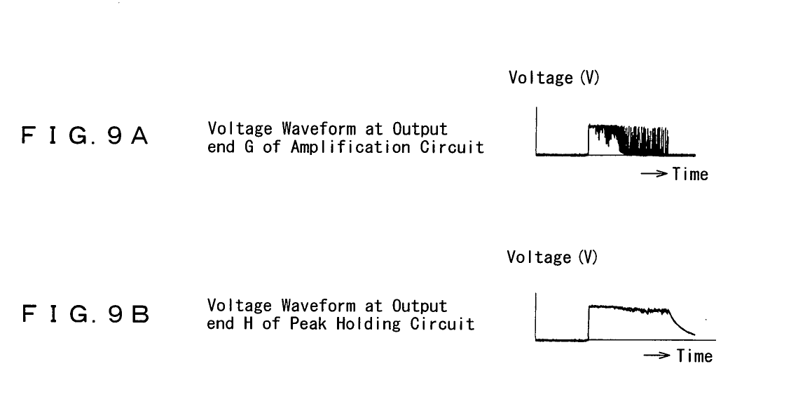

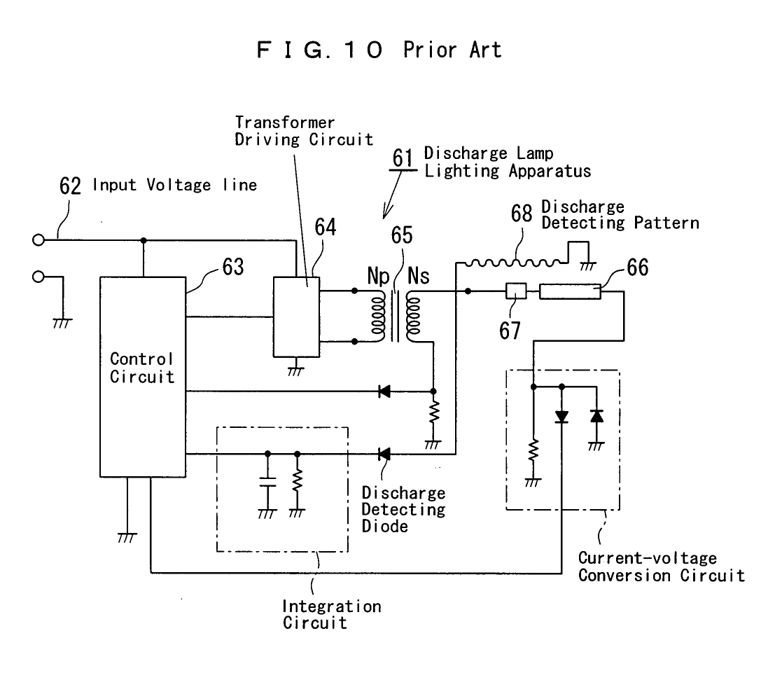

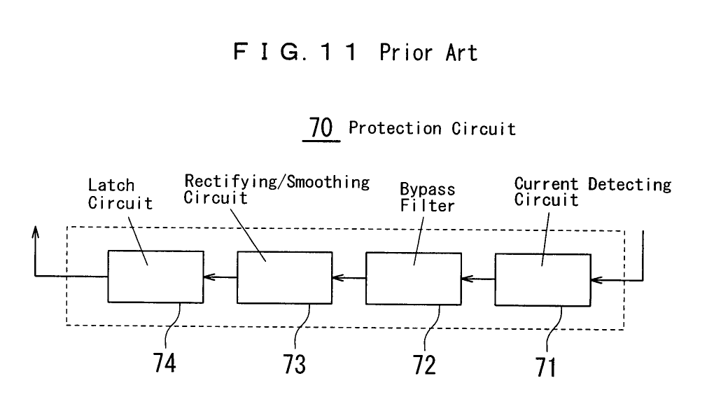

Description will now be made on a discharge lamp lighting apparatus according to a third embodiment of the present invention with reference to FIGS. 8, 9(a) and 9(b). FIG. 8 shows a circuitry of a discharge lamp lighting apparatus 1c according to the third embodiment. The discharge lamp lighting apparatus 1c shown in FIG. 8 has a basic composition in common with the discharge lamp lighting apparatus 1a shown in FIG. 2, and in FIG. 8 any component parts common to those in FIG. 2 are assigned the same reference numerals with description focused on the difference from the discharge lamp lighting apparatus 1a.

The discharge lamp lighting apparatus 1c according to the present embodiment differs from the discharge lamp lighting apparatus 1a in including a peak holding circuit 14 composed of a diode D1 and a capacitor C4, and in the example shown in FIG. 8 the output of an amplification circuit 10 is connected to the peak holding circuit 14 and the output of the peak holding circuit 14 is inputted to a comparison circuit 11.

The operation of the peak holding circuit 14 will be described with reference to FIGS. 9(a) and 9(b). FIG. 9(a) shows a voltage waveform at an output end G of the amplification circuit 10, and FIG. 9(b) shows a voltage waveform at an output end H of the peak holding circuit 14. In the discharge lamp lighting apparatus 1c, a high-frequency pulse signal detected by a discharge detecting pattern 6a passes through a signal discriminating circuit 8a, an integration circuit 9 and the amplification circuit 10, and is inputted to the peak holding circuit 14. The high-frequency pulse signal which is caused by an abnormal discharge has a very wide amplitude fluctuation as shown in FIG. 9(a), and if the signal is inputted to the comparison circuit 11 as is, a control circuit 2 may not detect a stop signal from the comparison circuit 11 due to the chattering of the output signal of a comparator CP1, which results in deteriorating the detection sensitivity of an abnormal discharge.

In dealing with the problem described above, the discharge lamp lighting apparatus 1c according to the present embodiment operates such that the peak holding circuit 14 detects a peak value of the high-frequency pulse signal from the amplification circuit 10 and holds the signal at the peak value, whereby the input signal to the comparison circuit 11 is stabilized as shown in FIG. 9(b) thus eliminating the chattering of the output signal of the comparator CP1, which allows an abnormal discharge to be reliably detected.

The discharge lamp lighting apparatus 1c according to the present embodiment has a basic composition in common with the discharge lamp lighting apparatus 1a according to the first embodiment, but it may be structured such that the discharge lamp lighting apparatus 1b according to the second embodiment includes a peak holding circuit 14.

The present invention has been described with reference to the preferred embodiments but is not limited to the embodiments described above, and various modifications are possible without departing from the spirit of the present invention.

For example, in the embodiments described above, the signal discriminating circuit includes a secondary differentiating circuit formed such that two primary RC differentiating circuits are connected to each other in cascade in two stages, but the signal discriminating circuit according to the present invention is not limited to such a composition. The signal discriminating circuit according to the present invention, for example, may alternatively include a tertiary or higher-order differentiating circuit in accordance with the increase of the frequency of switching noise associated with a further increase of the switching speed of a switching element included in the transformer driving circuit and/or may include a differentiating circuit using an active element such as an operation amplifier.

Further, the signal discriminating circuit according to the present invention performs its specific advantageous operation in attenuating a component of a voltage signal inputted from the discharge sensing circuit, the component having a frequency equal to or lower than a predetermined value, in a manner equal to or greater than a secondary high-frequency pass filter thereby allowing a high-frequency signal caused by an abnormal discharge to pass and blocking a high-frequency signal caused by a factor other than an abnormal discharge from passing, and does not necessarily have to function as a high-frequency pass filter itself over the entire frequency range. For example, the signal discriminating circuit may be a passband filter whose gain is re-attenuated at a frequency exceeding a frequency range at which a high-frequency signal caused by an abnormal discharge is found.

Also, in the embodiments described above, the discharge sensing circuit according to the present invention is a discharge detecting pattern disposed at the high-voltage wiring of the secondary side circuit of the transformer but may alternatively be connected to either the low voltage side of the high-voltage transformer or the ground side of the discharge lamp.

In the embodiments described above, the high-frequency noise caused by a factor other than an abnormal discharge is explained as switching noise, but the high-frequency noise to be eliminated by the signal discriminating circuit according to the present invention does not depend on the cause of noise generation. Included in the high-frequency noises to be eliminated by the signal discriminating circuit according to the present invention for improvement of the SN ratio of a detection signal of an abnormal discharge is, for example, a high-frequency noise emitted from a reception circuit of a television signal in the case if an object to be illuminated by the discharge lamp lighting apparatus is an LCD device of a television receiver.

1. A discharge lamp lighting apparatus including:
a transformer,
a transformer driving circuit,
a control circuit to control the transformer driving circuit, in which a primary side of the transformer is driven by the transformer driving circuit thereby lighting a discharge lamp connected at a secondary side of the transformer,
a discharge sensing circuit,
a signal detecting circuit to detect a voltage signal induced in the discharge sensing circuit, and
a protection means to stop supply of electric power to the secondary side of the transformer according to the voltage signal detected at the signal detecting circuit,
wherein the signal detecting circuit includes a signal discriminating circuit which attenuates a component of a voltage signal inputted from the discharge sensing circuit, the component having a frequency equal to or lower than a predetermined value, to be equal to or greater than a secondary high-frequency pass filter so as to pass only a high-frequency signal caused by an abnormal discharge.

2. A discharge lamp lighting apparatus as described in claim 1, wherein the signal discriminating circuit includes an nth (n≧2) differentiating circuit and one of a Schottky barrier diode and an ideal diode circuit connected to the nth differentiating circuit.

3. A discharge lamp lighting apparatus as described in claim 1, wherein the signal detecting circuit further includes a peak holding circuit disposed at an output side of the signal discriminating circuit.

4. A discharge lamp lighting apparatus as described in claim 1, wherein the discharge sensing circuit includes a discharge detecting pattern which has one end connected to ground and other end connected to the signal discriminating circuit, and at least one portion of which is located close to a high-voltage wiring of a secondary side circuit of the transformer.

5. A discharge lamp lighting apparatus as described in claim 4, wherein the discharge lamp lighting apparatus includes at least two sets of connection circuits each of which includes one discharge detecting pattern and one signal discriminating circuit.

6. A discharge lamp lighting apparatus as described in claim 2, wherein the signal detecting circuit further includes a peak holding circuit disposed at an output side of the signal discriminating circuit.

7. A discharge lamp lighting apparatus as described in claim 2, wherein the discharge sensing circuit includes a discharge detecting pattern which has one end connected to ground and other end connected to the signal discriminating circuit, and at least one portion of which is located close to a high-voltage wiring of a secondary side circuit of the transformer.

8. A discharge lamp lighting apparatus as described in claim 3, wherein the discharge sensing circuit includes a discharge detecting pattern which has one end connected to ground and other end connected to the signal discriminating circuit, and at least one portion of which is located close to a high-voltage wiring of a secondary side circuit of the transformer.

9. A discharge lamp lighting apparatus as described in claim 6, wherein the discharge sensing circuit includes a discharge detecting pattern which has one end connected to ground and other end connected to the signal discriminating circuit, and at least one portion of which is located close to a high-voltage wiring of a secondary side circuit of the transformer.
